(19) United States
(12) Patent Application Publication
(10) Pub. No.: US 2014/0201376 A1
(43) Pub. Date: Jul. 17, 2014

(54) METHOD AND SYSTEM FOR THE HANDLING OF REDUNDANT LONG POLL

(71) Applicants: Andre GODIN, Laval (CA); Ganish KATYAL, Saint-Laurent (CA); Robert HUIE, Saint-Laurent (CA)

(72) Inventors: Andre GODIN, Laval (CA); Ganish KATYAL, Saint-Laurent (CA); Robert HUIE, Saint-Laurent (CA)

(21) Appl. No.: 13/739,262

(22) Filed: Jan. 11, 2013

(51) Int. Cl. H04L 29/06

(52) U.S. Cl. CPC H04L 65/1069
USPC 709/227

(57) ABSTRACT

A server for handling long poll requests receives requests containing both a client identifier and an indication of a last long poll execution time. These parameters allow the server to determine if resources dedicated to previous long polls from the client have been released. If there may still be resourced dedicated, they are released so that the new poll can be established and no redundant long polls are maintained.

### TECHNICAL FIELD

This disclosure relates generally to the manner in which long poll requests are handled to reduce the number of redundant long polls created at a server.

### BACKGROUND

In Internet Protocol (IP) interactions, servers receive requests from clients and respond to the open requests. This request-response perspective typically precludes a true push based interaction where the server can push information to the client when needed. Numerous interactions in which a server push would be desirable have arisen as real-time interactions have increased. Common needs for a push-based service include email delivery, chat sessions through a server, as well as other increasingly demanding fields including the delivery of content in Internet Protocol Television (IPTV) environment. In IPTV environments, a terminal (such as a set top box (STB)) may request updates to an electronic programming guide.

Instead of having the terminal poll the server at short intervals to determine if there is new content available a technique referred to as long polling has arisen. A long poll is a request issued by the client node that has a long expiry associated with it. When the server receives the request it will check to see if there has been any updates since the last response sent to the client (which may be done through the client providing an indication of the last response either as a timestamp of the last transmission or through the provision of a flag indicating the last time that the content was updated). If there has been no updated content since the last request, the server will hold off on replying until new content is available. Because there is an open request, the server is responding to the earlier request and not technically pushing content, though the experience to the user is effectively the same.

There are several known issues surrounding the use of long polling. One of the issues is that requests cannot be left open indefinitely. To address this, a timeout is typically associated with each long poll request. If no new content is available by the expiry of the timer, the server will respond. Typically to prevent unnecessarily sending redundant data, at the expiry of the long poll a server will respond with a NULL valued response. Upon receipt of a response, NULL valued or otherwise, the client will typically send another long poll request so as to allow the server to respond when new data becomes available.

The use of long polls put the responsibility on the server to maintain an open connection for each client that connects to it. It is possible that a client will have disconnected before the long poll is responded to. In such a case, the server will have unnecessarily consumed resources unless the client gracefully closed the session.

In many IP based connections, there are intermittent failures of the connection between the server and the client. Due to the nature of the TCP protocol suite as an idle protocol, an interrupted connection is considered to be active unless a node is otherwise aware or informed of the termination. This is done as a design choice as a failure at an intermediate node between the server and client may be resolved before either one is aware of the problem, in which case the connection will not need to be re-established. However if the failed connection is identified by a client with an open long poll, the recovery of the connection will often entail the client reconnecting to the server and issuing a new long poll. This will result in a redundant long poll open at the server until it is responded to with either new data or a NULL response.

Where there are a small number of clients connecting over reliable channels, the leakage of redundant long polls is manageable. However, in deployments with a large number of clients, where the clients may not have reliable connections, there can be a great deal of wasted resources on these redundant connections. Furthermore, in environments where the server is a node in a server cluster, reducing the number of redundant connections can result in reducing the need for additional servers. In a virtualized server environment, where the server functions are provided by a data center, reducing the resources consumed by redundant connections can reduce the cost of operating the virtualized server cluster. As such, there is a great deal of interest in reducing the number of redundant connections.

FIG. 1 illustrates a conventional method of handling long polls. In step 50, the server receives a long poll request from a client. The long poll request received in step 50 may specify a keep_alive_timeout value that specifies how long the poll should remain open for, alternatively there could be a system default value used in the absence of a specified value. It should be understood that a keep_alive_timeout value specifies a maximum time within which the server can respond to the request. If the keep_alive_timeout value is exceeded without a response being sent, the server will respond with a NULL response and close the connection. As will be seen below, a bigger keep_alive_timeout will reduce the number of NULL responses received by a client, but may increase the likelihood of the server reserving resources for redundant connections. In step 52, a timer is set to the keep_alive_timeout and is initiated and the server allocates resources to the long poll request. The system then waits in step 54 for a determination in step 56 that the timer has expired. If in step 56 it is determined that the timer has not expired, the system returns to waiting in step 54. Alternatively, at the expiry of the timer, the server transmits a NULL response to the client in step 58, and then closes the open poll and releases the reserved resources in step 60. If, during the waiting of step 54, new data associated with the long poll arrives, as shown in step 61, a response is transmitted to the client based on the arriving new data in step 62 and the process completes with step 60 as described above. It should be understood that if the client, or the client's connection, is reset, and a new session is started during the waiting of step 54, the server will not be aware of this due to the restful nature of the long poll handling. The client, however, will initiate a second long poll that will start the same process again. This creates a situation in which the server will maintain two (or more) sets of resource reservations for the client until either new data arrives or until the originally set timer expires. Where only one client does this, and only does it once, there is little impact on the server. However, in a production environment, a large number of clients could be starting redundant long polls which will adversely affect performance.

FIG. 2a illustrates an alternate solution, whereby a server in a cluster makes use of a client identifier (clientid) provided in the Long Poll Request to ensure that redundant connections are prevented. In step 64 a Long Poll Request with a client identifier is received. In step 66, the server determines whether a Long Poll associated with the clientid is already present on that server. If there is an existing long poll, the old connection is assumed to be redundant and is released in step 68, and a the new long poll is setup in step 70. If, in step 66, it is determined that the server doesn't have a long poll associated with the clientid, the clientid is broadcast to the other nodes in the server cluster in step 72 and the new long poll is setup in step 70. By carrying out this method, a server is able to ensure that it does not host redundant open long polls, and is able to notify the other servers in the cluster that there is a long poll being established that may make a long poll hosted by one of them redundant.

FIG. 2b illustrates a method carried out by servers in the same cluster as the server of FIG. 2a. In step 74, the server receives a message from a peer node in the cluster indicating that a long poll associated with a clientid has been established. This will make a long poll associated with the clientid hosted by another server redundant. As such, the receiving server performs the analysis of step 66 to determine if there is a long poll associated with the clientid. If there is a long poll associated with that client id, it is closed in step 68. If there is no such long poll, the server does nothing as illustrated in step 76.

The combination of the methods of FIGS. 2a and 2b are an effective mechanism to prevent redundant long polls across a cluster. However, this method can result in a large amount of traffic generated between the nodes in the server cluster. If a large number of clients connect in a short period of time, to an n-node cluster, each of the connections will result in n different notifications being transmitted. At best, there are n−2 nodes that don't care about the message and will unnecessarily do nothing. At worst, the connection is not redundant and all n nodes will end up doing nothing (save for the 1 node that will create the connection). It may be possible to reduce the inefficiency through the use of a centralized database that tracks open connections by client id. Instead of broadcasting in step 72, the server can send the clientid to the central database. If there is an existing connection, either the database or the server can notify the node already hosting the connection. Although this will alleviate possible messaging storms in the cluster, it does require additional resources and any situation that would have resulted in a messaging storm will still result in a large number of connections to the database, which may overwhelm it.

Those skilled in the art will appreciate that preventing redundant long polls using a clientid is far easier in a single server environment. Accordingly, the use of a load balancer that ensures client stickiness to a particular server will reduce server-side complexity, but stickiness in client assignment can be counter productive to load balancing, and increases the complexity of the load balancing node.

One skilled in the art will appreciate that there is a need for a method of reducing the complexity of preventing redundant long poll connections in a clustered server environment so as to reduce the inter-server messaging while still preventing redundant connections.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided, a method for handling redundant long poll requests from a client. The method is typically executed at a server and comprises the steps of identifying that a request received over a network interface is a request to establish a first long poll in a new session with the client; determining, in accordance with parameters of the received request, that a long poll from a previous session with the client could still be active; responsive to the determination, clearing any connection associated with the previous session with the client; and establishing the requested long poll in the new session.

In an embodiment of the first aspect of the present invention, the step of identifying includes determining that the received long poll request includes a last execution time, and optionally the step of determining that a long poll from a previous session could still be active includes determining that the difference between a current time and the last execution time is below a threshold which may be a long poll timeout value included in the received request. In another embodiment, the step of clearing any connection associated with the previous session includes clearing any connection for a long poll on the server associated with a client identifier included in the received request. In an alternate embodiment, the step of clearing any connection associated with the previous session includes transmitting a notification to peer servers in a cluster to clear any connection associated with a client identifier included in the received request, where this step is optionally performed upon determining that there are no local connections associated with the client identifier at the server. In another embodiment, the method further includes the steps of responding to the established long poll; receiving from the client a request to establish a subsequent long poll in the new session; and establishing the requested subsequent long poll in the new session. Optionally, the method can further include the step of determining that the received request is a request to establish a subsequent session by determining that the received request does not include a last execution time, where optionally the step of establishing the requested subsequent long poll is performed without an attempt to clear connections associated with a previous session in response to the determination that the received request does not include a last execution time.

In a second aspect of the present invention, there is provided a method for handling redundant long poll requests from a client. The method can be carried out at a first server in a cluster and comprises the steps of identifying that a request received over a network interface is a request to establish a long poll in an existing session between the client and the cluster, where a server in the cluster has replied to a previous long poll; and responsive to the identification, establishing the requested long poll without attempting to clear a connection associated with the client.

In an embodiment of the second aspect of the present invention, the step of identifying includes determining that the server in the cluster has replied by determining that the received request does not include a last execution time.

In a third aspect of the present invention, there is provided a method of issuing a long poll request. The method can be carried out by a client node in a network and comprises the steps of determining that a long poll request is the first long poll request in a session; and responsive to the determination, transmitting the long poll request with an indication of the last execution time of a long poll in a previous session.

In an embodiment of the third aspect of the present invention, the step of transmitting further includes including, in the long poll request, at least one of a client identifier and a long poll timeout. In a further embodiment of the present invention, the method can include the steps of receiving a reply to the requested long poll; and transmitting a subsequent long poll request without an indication of a last execution time of any previous long poll.

In a fourth aspect of the present invention, there is provided a server for handling the receipt of long poll request and the establishment of long poll requests. The server comprises a network interface, a data repository and a processor. The network interface receives the long poll request from a client. The data repository stores instructions. The processor, upon execution of the instructions stored in the data repository identifies that the received request is one of a request to establish a first long poll in a session and a request to establish a subsequent long poll in a session, establishes the requested long poll without attempting to clear a connection associated with the client in response to identifying that the received request is a request to establish a subsequent long poll, and establishes the requested long poll upon clearing any connection associated with a previous session with the client in response to identifying both that the received request is a request to establish a first long poll and that a long poll from a previous session with the client could still be active.

In an embodiment of the fourth aspect of the present invention, the data repository additionally stores data to associate a client identifier with an established open long poll request for use in clearing a connection in response to receipt of a long poll request from the client in a new session. In another embodiment, the processor clears the connection associated with a previous session by transmitting a client identifier to a peer server in a cluster using the network interface.

In a fifth aspect of the present invention, there is provided a node for issuing long poll requests to a server. The node comprises a network interface, a data repository and a processor. The network interface transmits requests to, and receives replies from, servers connected to a network. The data repository stores instructions. The processor, upon execution of the instructions stored in the data repository, determines that a long poll request is the first long poll request in a session; responsive to the determination, transmits a long poll request over the network interface, the transmitted long poll request including an indication of the last execution time of a long poll in a previous session; receives a reply the transmitted long poll request over the network interface; and transmits a subsequent long poll request without an indication of a last execution time of any previous long poll.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flow chart illustrating a method of the prior art;

FIG. 2a is a flow chart illustrating a method of the prior art;

FIG. 2b is a flow chart illustrating a method of the prior art;

FIG. 3 is a flow chart illustrating a method for execution at a client node;

FIG. 4 is a call flow diagram illustrating a long poll communication between client and server nodes;

FIG. 5 is a flow chart illustrating a method for execution at a server node;

FIG. 6 is a flow chart illustrating an alternative implementation of the method of FIG. 5;

FIG. 7 is a flow chart illustrating an alternative implementation of the method of FIG. 5;

FIG. 8 is a flow chart illustrating an alternative implementation of the method of FIG. 5;

FIG. 9 is a call flow diagram illustrating an interaction where client and server nodes implement methods according to an embodiment of present invention; and

FIG. 10 is a block diagram illustrating an exemplary node of the present invention.

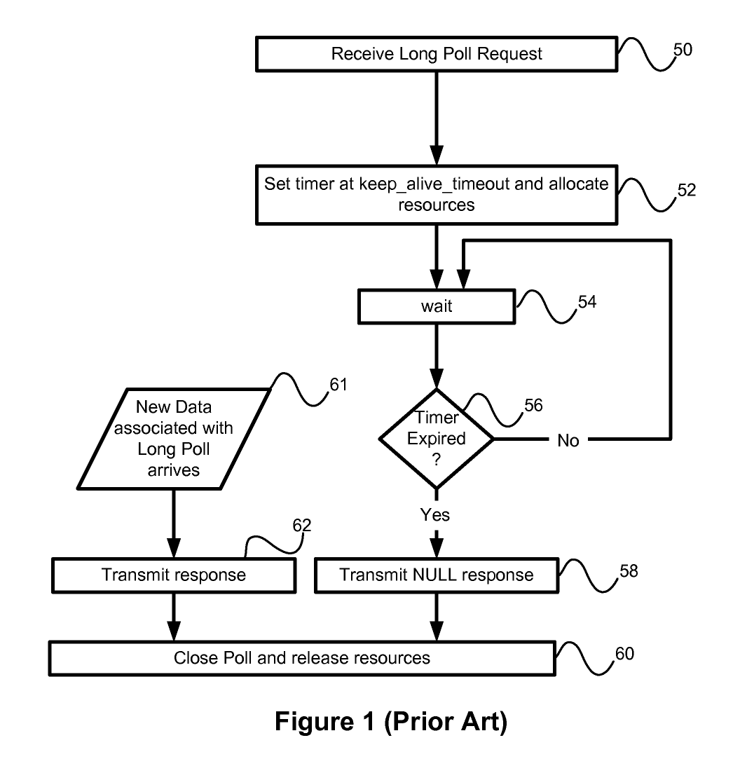

### DETAILED DESCRIPTION

The present invention is directed to a system and method for establishing long poll handling.

The following discussion of methods and nodes should be understood to be of particular use in a managed environment. As an example, in an IPTV environment, the clients and servers can be assumed to behave in controlled and predictable manners. As an example, a client can be designed to interact in a particular manner, and the server method can be designed to anticipate such a behavior pattern. In such an environment, it should be understood that it may be possible to design a client that would take advantage of the server methods to reduce the efficiency of the server, but that the managed nature of the nodes reduces the likelihood of such behavior. It should further be understood that although one intended use is in a managed environment, the use of these method still provides advantages in an unmanaged environment as long as some client nodes behave in the proscribed manner.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Discussions will first be directed to the behavior and methods of a client of the present invention. The following discussion will be provided in the context of a client being a terminal in an IPTV environment, and the server being a content provider, such as the provider of Electronic Programming Guide (EPG) content. Those skilled in the art will appreciate that these are exemplary roles and should not be considered to be restrictive.

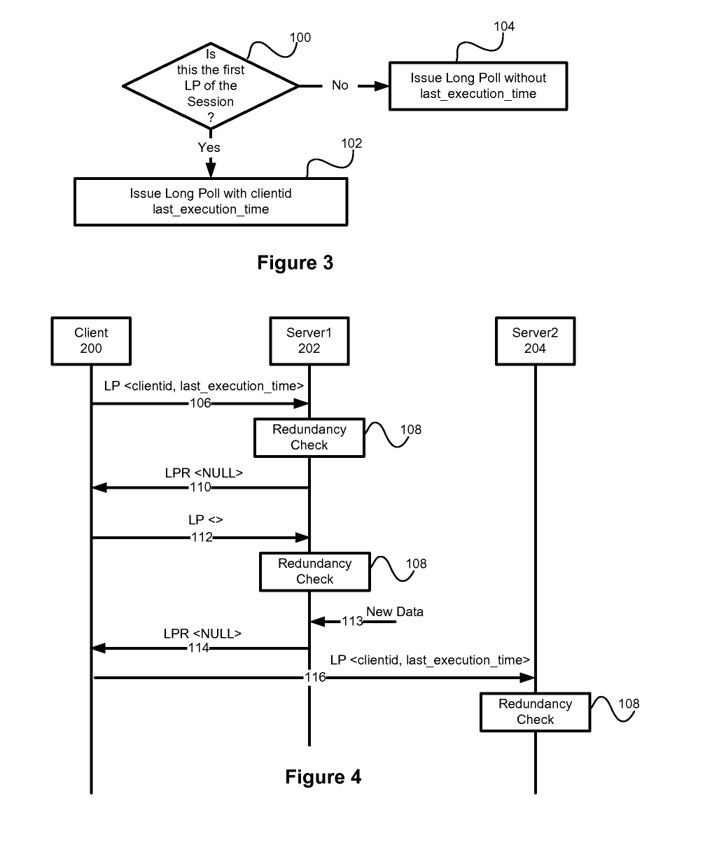

FIG. 3 illustrates an exemplary method for execution at a STB of the present invention. Upon determining that a Long Poll should be issued to the content server, the STB, at step 100 determines if this is the first Long Poll in a given session. If it is the first Long Poll in a session (e.g. the STB has just been reset or turned on), the method continues to step 102 where a Long Poll containing both a clientid and an indication of the last Long Poll Execution time are included. If the Long Poll is not the first LP of the session (e.g. a Long Poll was issued and responded to, and a new LP is being sent to maintain the open connection), then the LP can be issued in step 104 without the pairing of the clientid and the last execution time. One skilled in the art will appreciate that in step 104, the LP could alternatively be issued with a flag to indicate that this is not the first LP of the session.

The combination of the clientid and the last execution time will be used at the server to determine if there is a redundant open long poll. By including an indication that this is not the first LP of the session (the indication may be an explicit indicator or even the absence of either of the clientid or the last_execution_time), the client is providing the server and indication that there was a previous Long Poll issued in the session, and that it was responded to, which allows the server to determine that this request will not make a previous long poll redundant, as the previous long poll has been closed and the resourced dedicated towards it have been released.

FIG. 4 illustrates a call flow of the interaction between the client 200 and servers 202 and 204. In step 106, the client 200 issues the first long poll request of a session, and thus per the requirements of the flowchart of FIG. 3, the long poll request includes both the clientid and the last_execution_time of a previously executed long poll. This message is routed to server 1 202, which performs a redundancy check 108. The redundancy check 108 is performed to ensure that there are no redundant long polls, and an exemplary method is described in more detail below. In step 100, server 1 202 waits for new data until the expiry of the long poll. At the end of the timeout value associated with the long poll (which is usually provided as a parameter of the long poll request 106), server 1 202 responds with a Long Poll Response (LPR) with a null value in step 110. In step 112, the client issues a new Long Poll request. At this time, it is no longer the first request of the session, and accordingly, the Long Poll does not include the clientid and last_execution_time parameters. The request is again directed to server 1 202, which performs redundancy check 108 and then waits for either new data or the expiry of the timeout value. One skilled in the art will appreciate that the request could have been routed to any other node in the cluster, but for the purposes of this exemplary description, the second request is routed to the same server. When new data is available, Server 1 202 responds with Long Poll Response 114 which contains the data. Client 200, upon receipt of LPR 114 issues a new Long Poll request in LP 116. As this is again not the first request of the session, it does not include the clientid and last_execution_time parameters. This time, the request is routed (typically by a load balancer not shown for the sake of simplicity) to server 2 204. Server 2 204 performs redundancy check 108 and establishes the connection. Attention will now be directed to the server implemented redundancy check of step 108.

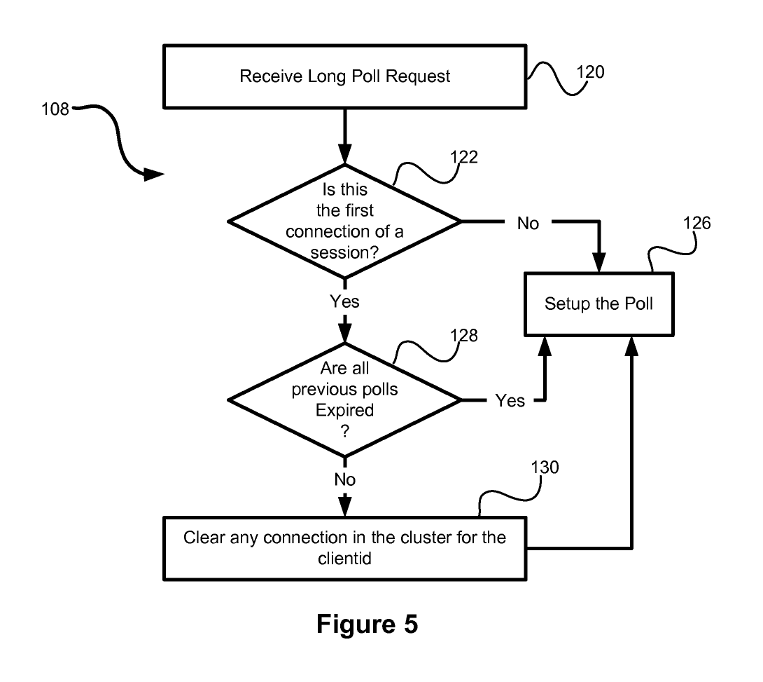

FIG. 5 illustrates an exemplary embodiment of redundancy check 108. In step 120, a long poll request is received at a server, which is typically a server in a cluster. The server then determines if the received long poll request is the first long poll from the client in the current session in step 122. As noted earlier this can either be through an explicit indication from the client, or through determining if certain information indicative of this state is either included or not included. If this is not the first long poll request of the session it is assumed that the client is not intentionally creating redundant long polls, and the long poll is set up in step 126. The setup of a long poll will be well understood by those skilled in the art, and is outside the necessary discussion provided here.

If it is determined that the received long poll request is the first long poll of a session, it is possible that a previous connection to the client has failed. At this point, the server examines, in step 128, information provided in the request to determine if it can be established that any previous polls have expired. If, based on the parameters provided with the long poll, it is determined that any polls from a previous session have expired (e.g. the previous session was ended when a user turned off a STB at night and the new session has begun the following evening, and any previous long poll request would have timed out), the method continues to step 126 as before. If it cannot be determined that any possible previous long polls have expired, the server will invoke a procedure in step 130 to clear any connections in the cluster associated with the client who issued the long poll request. Upon invoking this procedure, the server can proceed to setup the long poll in step 126 as before.

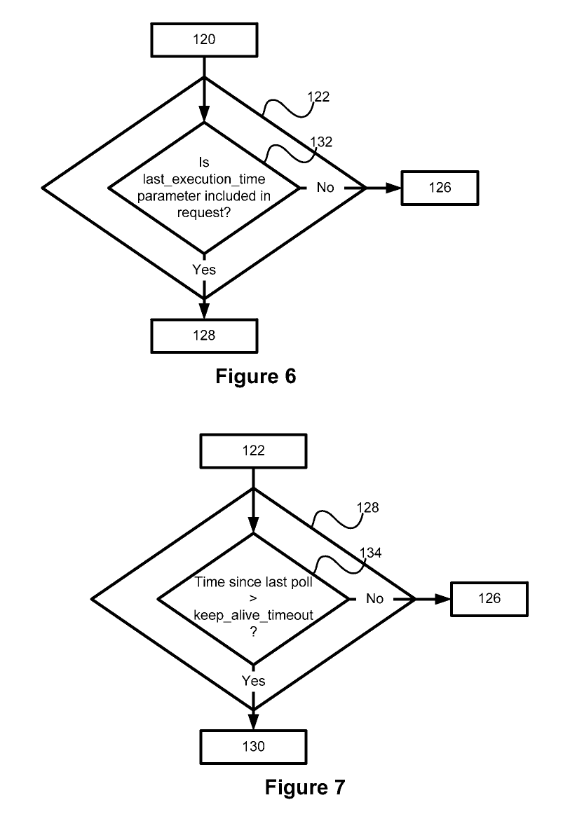

FIG. 6 illustrates an exemplary embodiment of the step 122 in FIG. 5. In step 122 of FIG. 5, the server attempts to determine if the received long poll request is the first long poll request of a session. This could be done through the use of a flag used on the first long poll request of a session, it could alternatively be done through the absence of a flag used on all subsequent requests of a session. In the illustrated embodiment of FIG. 6, step 122 includes examining the request received in step 120 to determine if the last_execution_time parameter is provided. This is carried out in step 132. If the client is acting under the method of FIG. 3, the inclusion of this parameter is indicative of the first long poll request of the session, and the positive evaluation of step 132 results in a positive evaluation of step 122. Accordingly, the negative evaluation of step 132 results in a negative evaluation of step 122. The results of the evaluation of step 122 are carried out as shown in FIG. 5.

FIG. 7 illustrates an exemplary embodiment of step 128 of FIG. 5 in which the server determines if any previous long polls have expired. In the embodiment of FIG. 7, step 128 includes determining, in step 134, if the time since the long poll of a previous session is greater than the long poll timeout value. If the last long poll was issued a sufficiently long time ago, it would have either been responded to or closed by the expiry of the long poll timeout. This determination can be made by evaluating the time since a last_execution_time parameter provided in the received long poll request. If the difference between the last_execution_time and the current time is greater than the long poll timeout value associated with the long poll request, the server can assume that any previous long polls have expired, and resulting positive evaluation will allow the process to continue to step 126. If the difference between the current time and the last_execution_time is smaller than the long poll timeout value, and it is the first poll of a session, it is possible that the client has crashed with an open poll that has not been responded to. As a result, the process would continue to step 130 as shown in FIG. 5.

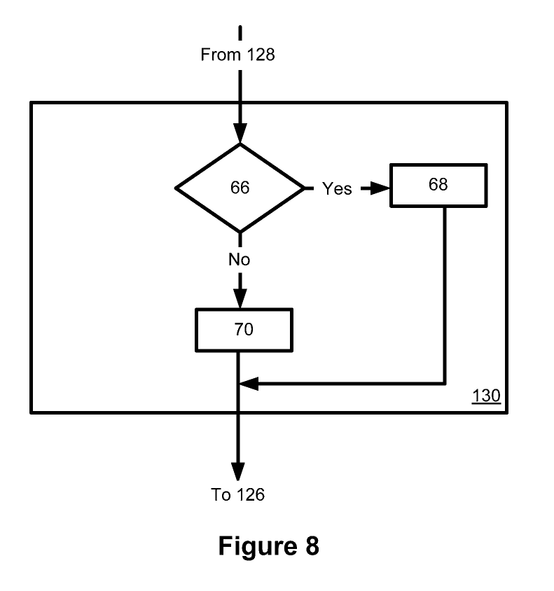

If it has been determined that there may be open long polls associate with the client sending the request received in step 120 of FIG. 5, the server will ensure that any servers in the cluster that may have open connections is notified so that it has the chance to close the connection, as the setup of a new long poll will make the existing connection redundant. This notification process is carried out in step 130 of FIG. 5. FIG. 8 illustrates an exemplary embodiment of such a process in which the server clears connections associated with the clientid in the cluster. It should be understood that when a client resets and reconnects within the keep_alive_timeout window that there is a likelihood that there are existing long polls that have not been responded to. It is also possible that any existing long polls were responded to, either prior to the client reset (which could happen immediately after receipt of a long poll response but before a new long poll has been received) or during the time period between the client disconnection and the session re-establishment.

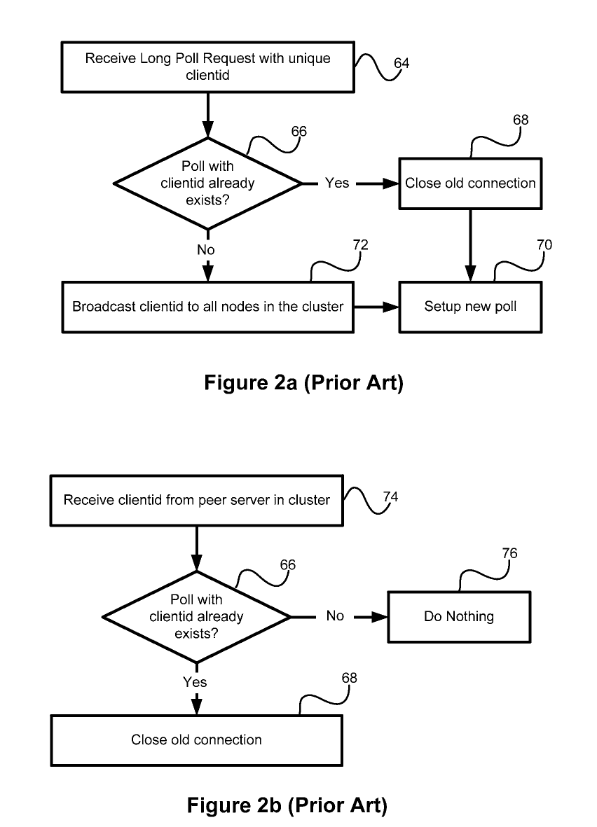

Upon the negative evaluation of step 128, in step 130, the server determines if it has an open poll associated with the clientid of the received request in step 66. If there is an open poll at the server for the clientid, the old connection is closed in step 68. If such a poll exists on the server, it can be assumed that no other server in the cluster will have a redundant poll, and the process can continue on to step 68 in which the server will close the open poll. If there is no open poll at the server for the clientid, the server will broadcast the clientid to the other servers in the clusters in step 70. Because there is a possibility for an open poll at another server due to the keep_alive_timeout window, and the server having no indication that there cannot be a poll on another server, the broadcast can be justified as a consumption of bandwidth. One skilled in the art will appreciate that each server in the cluster can implement a method such as that illustrated in FIG. 2b to handle messages from the other servers in the cluster. Upon completion of either step 68 or 72, the process continues to step 126 as shown in FIG. 5.

One skilled in the art will appreciate that step 130 could be implemented as the execution of steps 70 and 68 (in either order or in parallel) without the decision of step 66. Upon completion of the steps 68 and 72, the process would then continue to step 126. The use of decision step 66 allow for a reduction in the amount of traffic generated between nodes in the cluster, which will be understood by those skilled in the art as being advantageous.

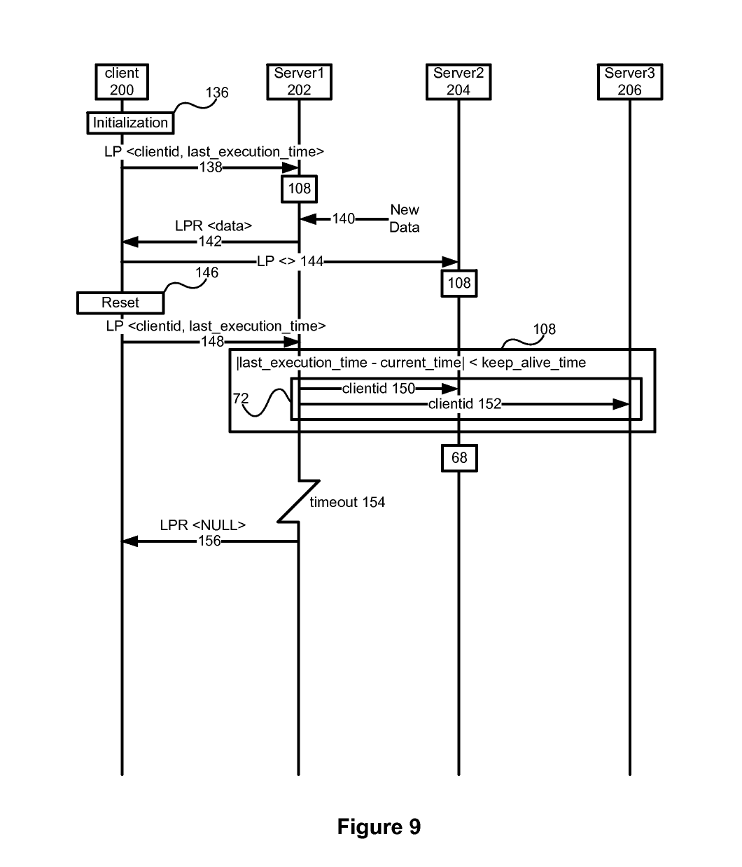

FIG. 9 illustrates a call flow showing a client 200 communicates with the servers in a cluster. It will be understood that when client 200 issues a request it is received by a load balancing node that directs the request to one of server1 202, server2 204 and server3 206. The load balancing node is not shown for the sake of simplicity. In step 136, the client is initialized. At this point, the Long Poll request 138 will be the first long poll of the session, and accordingly, it is issued with both the clientid and the last_execution_time. This long poll is routed to server1 202, which then performs the steps of method 108 to determine if there is an existing long poll made redundant by this long request. As this is the first poll, and there are no previously pending long polls, the long poll is established without any redundant poll handling. In step 140, server1 202 receives new data that satisfies the request of long poll 138, and issues a long poll response LPR 142 containing data determined in accordance with new data 140. Upon receipt of the LPR 142, client 200 issues a new long poll request 144 that does not contain the last_execution_time, as it is not the first long poll of a session. When client 200 issues a poll that is not the first long poll of a session, it is a clear indicator that there are no existing long polls that would be made redundant by this request. The LP 144 is routed to server 2 204, which performs the redundancy check 108 and establishes the long poll. In step 146 the client 200 is reset. Upon re-initialization of the client 200, a long poll 148 is issued. As the reset 146 has occurred, long poll 148 is the first long poll of a new session, and the clientid and last_execution_time are included in the request. LP 148 is routed to server1 202, which performs redundancy check 108. During this check it is determined that the difference between the last execution time and the current time is less than the keep alive timer. This indicates that there is the possibility that a server in the cluster will have an open long poll that will be made redundant by the establishment of the long poll. Server1 202 determines that it does not have any existing long polls associated with the client id (not shown) and in step 72 transmits the clientid to the other servers in the cluster in messages 150 and 152. Server1 202 then establishes the long poll. Server 2 204 upon receipt of the clientid in message 150 determines that is has an open long poll associated with the clientid and in step 68 closes the open poll and releases the reserved resources.

In step 154, server1 202 determines that sufficient time has elapsed since the establishment of the long poll concluding step 108, that the keep_alive_timeout 154 has expired. Server1 202 will then issue a long poll response with a null value, LPR <NULL> 156. At this point, client 200 can issue a new LP that will be routed to a server and handled as described above.

One skilled in the art will appreciate that where a client has never issued a long poll request before (e.g. when the client is brand new), there may not be a value for the last_execution_time. In such a case, the client may issue a request with a NULL value for the last_execution_time, as it would not be possible for such a client to be creating a redundant long poll request.

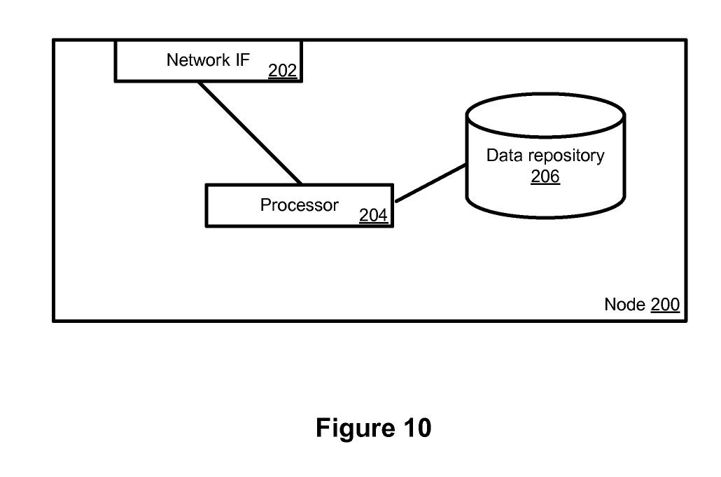

FIG. 10 illustrates an exemplary node 250 of the present invention having a network interface 252, a processor 254 and a data repository 256 for storing instructions that when executed by the processor 254 allow the node 250 to carry out the methods described above. When used as client 200, node 250 stores an indication of whether there is an existing session in data repository 256 so that when a new long poll is issued, processor 254 can determine whether there is a need to include an indication that the long poll is the first poll of a new session. As noted above, the indication can be a flag or it could simply be the inclusion of the last_execution_time value. It should be noted that the use of a flag for this purpose can be implemented in a system in which the client 200 always transmits the last_execution_time value.

When used as a server such as server1 202, node 250 additionally stores, in data repository 256, a mapping between open long poll connections and the clientid with which they are associated. This allows node 250 to determine (either during redundancy check 108 or in response to receipt of a clientid as a result of step 130 being carried out on another node in the server cluster) whether there are open polls associated with a particular clientid.

Node 250 may be implemented on conventional hardware including general purpose computing platforms, or on more specialized hardware designed for a particular purpose. It should be understood that the processor 254 and data repository 256 can be used for other purposes outside of the present invention as well.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for handling redundant long poll requests from a client, the method for execution at a server and comprising:
identifying that a request received over a network interface is a request to establish a first long poll in a new session with the client;
determining, in accordance with parameters of the received request, that a long poll from a previous session with the client could still be active;
responsive to the determination, clearing any connection associated with the previous session with the client; and
establishing the requested long poll in the new session.

2. The method of claim 1 wherein the step of identifying includes determining that the received long poll request includes a last execution time.

3. The method of claim 2 wherein the step of determining that a long poll from a previous session could still be active includes determining that the difference between a current time and the last execution time is below a threshold.

4. The method of claim 3 wherein the threshold is a long poll timeout value included in the received request.

5. The method of claim 1 wherein the step of clearing any connection associated with the previous session includes clearing any connection for a long poll on the server associated with a client identifier included in the received request.

6. The method of claim 1 wherein the step of clearing any connection associated with the previous session includes transmitting a notification to peer servers in a cluster to clear any connection associated with a client identifier included in the received request.

7. The method of claim 6 wherein the step of transmitting is performed upon determining that there are no local connections associated with the client identifier at the server.

8. The method of claim 1 further comprising:
responding to the established long poll;
receiving from the client a request to establish a subsequent long poll in the new session; and
establishing the requested subsequent long poll in the new session.

9. The method of claim 8 further comprising the step of determining that the received request is a request to establish a subsequent session by determining that the received request does not include a last execution time.

10. The method of claim 9 wherein the step of establishing the requested subsequent long poll is performed without an attempt to clear connections associated with a previous session in response to the determination that the received request does not include a last execution time.

11. A method for handling redundant long poll requests from a client, the method for execution at a first server in a cluster and comprising:
identifying that a request received over a network interface is a request to establish a long poll in an existing session between the client and the cluster, where a server in the cluster has replied to a previous long poll; and
responsive to the identification, establishing the requested long poll without attempting to clear a connection associated with the client.

12. The method of claim 11 wherein the step of identifying includes determining that the server in the cluster has replied by determining that the received request does not include a last execution time.

13. A method of issuing a long poll request from a client, the method comprising:
determining that a long poll request is the first long poll request in a session; and
responsive to the determination, transmitting the long poll request with an indication of the last execution time of a long poll in a previous session.

14. The method of claim 13 wherein the step of transmitting further includes including, in the long poll request, at least one of a client identifier and a long poll timeout.

15. The method of claim 15 further comprising the steps of:
receiving a reply to the requested long poll; and
transmitting a subsequent long poll request without an indication of a last execution time of any previous long poll.

16. A server for handling the receipt of long poll request and the establishment of long poll requests, the server comprising:
a network interface for receiving the long poll request from a client;
a data repository for storing instructions;
a processor, which upon execution of the instructions stored in the data repository
identifies that the received request is one of a request to establish a first long poll in a session and a request to establish a subsequent long poll in a session,
establishes the requested long poll without attempting to clear a connection associated with the client in response to identifying that the received request is a request to establish a subsequent long poll, and
establishes the requested long poll upon clearing any connection associated with a previous session with the client in response to identifying both that the received request is a request to establish a first long poll and that a long poll from a previous session with the client could still be active.

17. The server of claim 16 wherein the data repository additionally stores data to associate a client identifier with an established open long poll request for use in clearing a connection in response to receipt of a long poll request from the client in a new session.

18. The server of claim 16 wherein the processor clears the connection associated with a previous session by transmitting a client identifier to a peer server in a cluster using the network interface.

19. A node for issuing long poll requests to a server, the node comprising:
a network interface for transmitting requests to, and receiving replies from, servers connected to a network;
a data repository for storing instructions; and
a processor, which upon execution of the instructions stored in the data repository
determines that a long poll request is the first long poll request in a session;
responsive to the determination, transmits a long poll request over the network interface, the transmitted long poll request including an indication of the last execution time of a long poll in a previous session;
receives a reply the transmitted long poll request over the network interface; and
transmits a subsequent long poll request without an indication of a last execution time of any previous long poll.
